(19) United States
(12) Patent Application Publication
(10) Pub. No.: US 2024/0311714 A1
(43) Pub. Date: Sep. 19, 2024

(54) TECHNIQUES FOR WORKFORCE MANAGEMENT IN A TASK ASSIGNMENT SYSTEM

(71) Applicant: Afiniti, Ltd., Hamilton (BM)

(72) Inventor: Denys LIUBYVYI, Washington, DC (US)

(73) Assignee: Afiniti, Ltd., Hamilton (BM)

(21) Appl. No.: 18/615,815

(22) Filed: Mar. 25, 2024

Related U.S. Application Data
(63) Continuation of application No. 17/572,030, filed on Jan. 10, 2022, now Pat. No. 11,972,376.
Application No. 17/572,030 is a continuation of application No. 15/993,498, filed on May 30, 2018, now Pat. No. 11,250,359.

(51) Int. Cl. G06Q 10/0631; G06Q 10/0639

(52) U.S. Cl. CPC G06Q 10/063114; G06Q 10/06312; G06Q 10/06398

(57) ABSTRACT

Techniques for workforce management in a task assignment system are disclosed. In one particular embodiment, the techniques may be realized as a method for workforce management in a task assignment system comprising: determining, by at least one computer processor configured to operate in the task assignment system, a first efficiency level of a first task assignment strategy for a first number of agents to be employed in the task assignment system; determining, by the at least one computer processor, a second efficiency level of a second task assignment strategy for a second number of agents to be employed in the task assignment system; comparing, by the at least one computer processor, the first and second efficiency levels; and selecting, by the at least one computer processor, one of the first and second numbers of agents having the higher of the first and second efficiency levels.

### CROSS-REFERENCE TO RELATED APPLICATIONS

This application is a continuation of U.S. patent application Ser. No. 17/572,030, filed on Jan. 10, 2022, which is a continuation of U.S. patent application Ser. No. 15/993,498, filed on May 30, 2018 (now U.S. Pat. No. 11,250,359). The disclosures of each of the identified applications are incorporated herein by reference in their entirety.

This patent application is related to U.S. patent application Ser. No. 15/395,469, filed Dec. 30, 2016, and co-pending U.S. patent application Ser. No. 15/993,496, filed May 30, 2018, which are hereby incorporated by reference herein in their entirety.

### FIELD OF THE DISCLOSURE

This disclosure generally relates to pairing tasks and agents in a task assignment system and, more particularly, to techniques for workforce management in a task assignment system.

### BACKGROUND OF THE DISCLOSURE

A typical task assignment system algorithmically assigns tasks (or contacts) arriving at the task assignment system to agents available to handle those tasks. At times, the task assignment system may have agents available and waiting for assignment to inbound or outbound tasks (e.g., telephone calls, Internet chat sessions, email). At other times, the task assignment system may have tasks waiting in one or more queues for an agent to become available for assignment.

In some typical task assignment systems, tasks are assigned to agents based on time of arrival, and agents receive tasks based on the time when those agents became available. This strategy may be referred to as a “first-in, first-out,” “FIFO,” or “round-robin” strategy. In other typical task assignment systems, other strategies may be used, such as “performance-based routing,” or a “PBR,” strategy.

Typical task assignment systems preferentially minimize overall agent idle time and overall task waiting time. To that end, if tasks are waiting in a queue, a task will be assigned to an agent soon after an agent becomes available for assignment. Similarly, if agents are idle, waiting for tasks to arrive, an agent will be assigned to a task soon after a task becomes available for assignment.

In typical a task assignment system, managers generally try to staff queues with the exact number of agents needed to handle forecasted volume of tasks-no more, no less. This approach tends to maximize 1-to-1 (i.e., one task to one agent) routing as much as possible, minimizing the number of agents waiting idle and the number of tasks waiting in a queue.

However, a workforce management that strives for 1-to-1 routing does not allow a task assignment system to improve or maximize its benefits by using a pairing strategy that is designed to choose among multiple possible pairings.

In view of the foregoing, it may be understood that there may be a need for a workforce management in a task assignment system that improves the efficiency and performance of pairing strategies that are designed to choose among multiple possible pairings.

### SUMMARY OF THE DISCLOSURE

Techniques for workforce management in a task assignment system are disclosed. In one particular embodiment, the techniques may be realized as a method for workforce management in a task assignment system comprising: determining, by at least one computer processor configured to operate in the task assignment system, a first efficiency level of a first task assignment strategy for a first number of agents to be employed in the task assignment system; determining, by the at least one computer processor, a second efficiency level of a second task assignment strategy for a second number of agents to be employed in the task assignment system; comparing, by the at least one computer processor, the first and second efficiency levels; and selecting, by the at least one computer processor, one of the first and second numbers of agents having the higher of the first and second efficiency levels.

In accordance with other aspects of this particular embodiment, the task assignment system may be a contact center system, and wherein the first and second task assignment strategies may assign contacts to contact center system agents.

In accordance with other aspects of this particular embodiment, the first task assignment strategy may be a first-in first-out (FIFO) strategy, and wherein the second task assignment strategy may be a behavioral pairing (BP) strategy.

In accordance with other aspects of this particular embodiment, determining the second efficiency level may be based on an expected gain of using the second task assignment strategy with the second number of agents overusing the first task assignment strategy with the first number of agents.

In accordance with other aspects of this particular embodiment, determining the second efficiency level may be based on a cost of using the second task assignment strategy instead of the first task assignment strategy.

In accordance with other aspects of this particular embodiment, the second number of agents may be less than the first number of agents, and determining the second efficiency level may be based on a savings of using the second number of agents instead of the first number of agents.

In accordance with other aspects of this particular embodiment, determining the second efficiency level may further comprise determining, by the at least one computer processor, a cost of losing a portion of a plurality of tasks by estimating an expected loss of each task out of the portion of the plurality of tasks.

In accordance with other aspects of this particular embodiment, determining the second efficiency level may further comprise applying, by the at least one computer processor, a statistical analysis on historical data recorded by the task assignment system.

In another particular embodiment, the techniques may be realized as a system for workforce management in a task assignment system comprising at least one computer processor configured to operate in the task assignment system, wherein the at least one computer processor is further configured to perform the above method steps:

In another particular embodiment, the techniques may be realized as an article of manufacture for workforce management in a task assignment system comprising a non-transitory computer processor readable medium, and instructions stored on the medium, wherein the instructions may be configured to be readable from the medium by at least one computer processor configured to operate in the task assignment system and thereby cause the at least one computer processor to operate so as to perform the above method steps.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows a block diagram of a task assignment system according to embodiments of the present disclosure.

FIG. 2 depicts a schematic representation of a task assignment system timeline according to embodiments of the present disclosure.

FIG. 3 depicts a schematic representation of a choice-based pairing strategy according to embodiments of the present disclosure.

FIG. 4 depicts a schematic representation of timeline of a risk of abandonment of a task according to embodiments of the present disclosure.

FIG. 5 shows a flow diagram of a workforce management method according to embodiments of the present disclosure.

### DETAILED DESCRIPTION

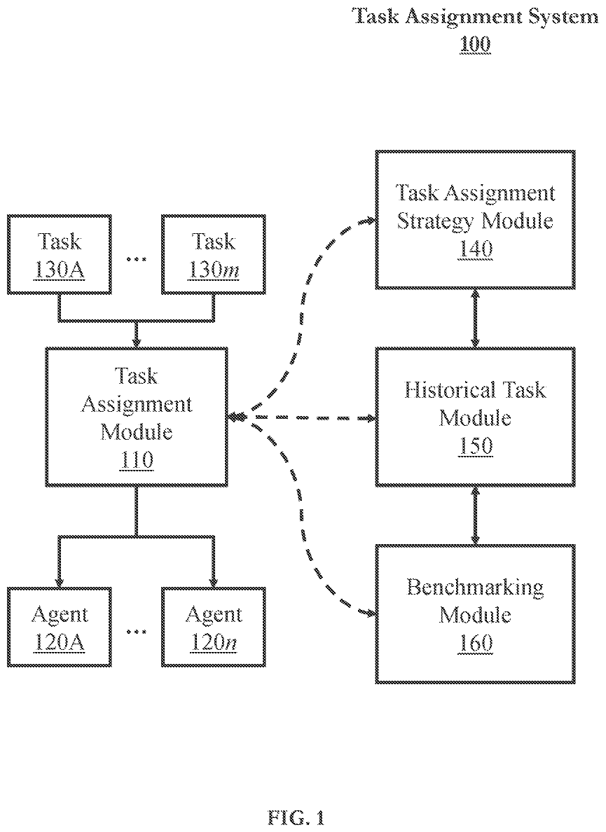

FIG. 1 shows a block diagram of a task assignment system 100 according to embodiments of the present disclosure. The description herein describes network elements, computers, and/or components of a system and method for benchmarking pairing strategies in a task assignment system that may include one or more modules. As used herein, the term “module” may be understood to refer to computing software, firmware, hardware, and/or various combinations thereof. Modules, however, are not to be interpreted as software which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

As shown in FIG. 1, the task assignment system 100 may include a task assignment module 110. The task assignment module 110 may include a switch or other type of routing hardware and software for helping to assign tasks among various agents, including queuing or switching components or other Internet-, cloud-, or network-based hardware or software solutions.

The task assignment module 110 may receive incoming tasks. In the example of FIG. 1, the task assignment system 100 receives m tasks over a given period, tasks 130A-130m. Each of the m tasks may be assigned to an agent of the task assignment system 100 for servicing or other types of task processing. In the example of FIG. 1, n agents are available during the given period, agents 120A-120n. m and n may be arbitrarily large finite integers greater than or equal to one. In a real-world task assignment system, such as a contact center, there may be dozens, hundreds, etc. of agents logged into the contact center to interact with contacts during a shift, and the contact center may receive dozens, hundreds, thousands, etc. of contacts (e.g., calls) during the shift.

In some embodiments, a task assignment strategy module 140 may be communicatively coupled to and/or configured to operate in the task assignment system 100. The task assignment strategy module 140 may implement one or more task assignment strategies (or “pairing strategies”) for assigning individual tasks to individual agents (e.g., pairing contacts with contact center agents).

A variety of different task assignment strategies may be devised and implemented by the task assignment strategy module 140. In some embodiments, a first-in/first-out (“FIFO”) strategy may be implemented in which, for example, the longest-waiting agent receives the next available task (in L1 environments) or the longest-waiting task is assigned to the next available task (in L2 environments). Other FIFO and FIFO-like strategies may make assignments without relying on information specific to individual tasks or individual agents.

In other embodiments, a performance-based routing (PBR) strategy may be used for prioritizing higher-performing agents for task assignment may be implemented. Under PBR, for example, the highest-performing agent among available agents receives the next available task. Other PBR and PBR-like strategies may make assignments using information about specific agents but without necessarily relying on information about specific tasks or agents.

In yet other embodiments, a BP strategy may be used for optimally assigning tasks to agents using information about both specific tasks and specific agents. Various BP strategies may be used, such as a diagonal model BP strategy or a network flow BP strategy. These task assignment strategies and others are described in detail for the contact center context in, e.g., U.S. Pat. Nos. 9,300,802 and 9,930,180, which are hereby incorporated by reference herein.

In some embodiments, a historical task module 150 may be communicatively coupled to and/or configured to operate in the task assignment system 100 via other modules such as the task assignment module 110 and/or the task assignment strategy module 140. The historical task module 150 may be responsible for various functions such as monitoring, storing, retrieving, and/or outputting information about agent task assignments that have already been made. For example, the historical task module 150 may monitor the task assignment module 110 to collect information about task assignments in a given period. Each record of a historical task assignment may include information such as an agent identifier, a task or task type identifier, outcome information, or a pairing strategy identifier (i.e., an identifier indicating whether a task assignment was made using a BP pairing strategy or some other pairing strategy such as a FIFO or PBR pairing strategy).

In some embodiments and for some contexts, additional information may be stored. For example, in a call center context, the historical task module 150 may also store information about the time a call started, the time a call ended, the phone number dialed, and the caller's phone number. For another example, in a dispatch center (e.g., “truck roll”) context, the historical task module 150 may also store information about the time a driver (i.e., field agent) departs from the dispatch center, the route recommended, the route taken, the estimated travel time, the actual travel time, the amount of time spent at the customer site handling the customer's task, etc.

The historical task module 150 may also store information about abandoned tasks, which expired or otherwise became abandoned or inoperable prior to assignment to an agent. For example, in a call center context, a caller on hold may decide to hang up and terminate a call before it is answered by an agent. The historical task module 150 may store information about the time a call arrived, the time a call was abandoned, the caller's menu or interactive voice response (IVR) selections, the caller's phone number, etc.

In some embodiments, the historical task module 150 may generate a pairing model or similar computer processor-generate model based on a set of historical assignments or other data, such as lost task data, for a period of time (e.g., the past week, the past month, the past year, etc.), which may be used by the task assignment strategy module 140 to make task assignment recommendations or instructions to the task assignment module 110. In other embodiments, the historical task module 150 may send historical assignment information to another module such as the task assignment strategy module 140 or the benchmarking module 160.

In some embodiments, a benchmarking module 160 may be communicatively coupled to and/or configured to operate in the task assignment system 100 via other modules such as the task assignment module 110 and/or the historical task module 150. The benchmarking module 160 may benchmark the relative performance of two or more pairing strategies (e.g., FIFO, PBR, BP, etc.) using historical assignment information, which may be received from, for example, the historical task module 150. In some embodiments, the benchmarking module 160 may perform other functions, such as establishing a benchmarking schedule for cycling among various pairing strategies, tracking cohorts (e.g., base and measurement groups of historical assignments), etc. The techniques for benchmarking and other functionality performed by the benchmarking module 160 for various task assignment strategies and various contexts are described in later sections throughout the present disclosure. Benchmarking is described in detail for the contact center context in, e.g., U.S. Pat. No. 9,712,676, which is hereby incorporated by reference herein.

In some embodiments, the benchmarking module 160 may output or otherwise report or use the relative performance measurements. The relative performance measurements may be used to assess the quality of the task assignment strategy to determine, for example, whether a different task assignment strategy (or a different pairing model) should be used, or to measure the overall performance (or performance gain) that was achieved within the task assignment system 100 while it was optimized or otherwise configured to use one task assignment strategy instead of another.

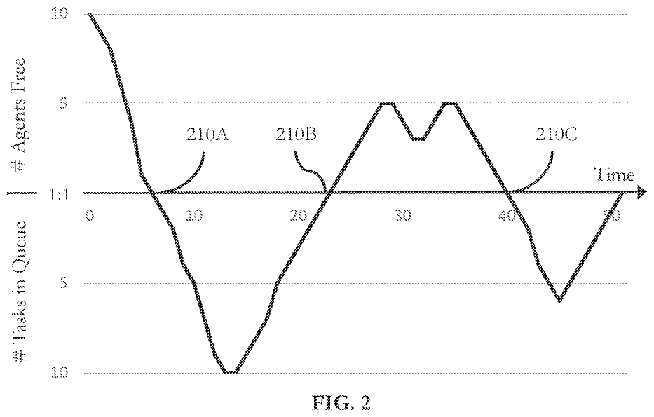

FIG. 2 depicts a schematic representation of a task assignment system timeline according to embodiments of the present disclosure. In a given period of time (e.g., over several minutes, several hours, a day), the number of agents free or available to connect to tasks, or the number of tasks waiting in queue, will vary continuously as tasks arrive and depart the task assignment system. The example of FIG. 2 depicts the capacity of a task assignment system over a period of time along the x-axis from time “0” to time “50” (e.g., 0 minutes to 50 minutes). The y-axis depicts the number of free agents or the number of tasks in queue above and below the x-axis, respectively.

At time 0 (e.g., when the task assignment system first opens at the beginning of the day), there are 10 agents available and waiting for tasks to arrive. Periods of time when a task assignment system has a surplus of available agents are referred to as “L1” environments. If a choice-based pairing strategy such as BP is used, the choice-based pairing strategy may choose from among any (or a subset) of the available agents when a task arrives.

As tasks arrive, and agents become occupied while communicating with those tasks, the number of available agents may decrease, as shown in FIG. 2 from time 0 to approximately time 5. The task assignment system is operating in an L1 environment for this entire duration, but the choice available to BP or another choice-based pairing strategy becomes increasingly limited-instead of having as many as ten (or more) agents available to choose among, by about time 5 there are only two or three agents to choose among.

At other periods of time, there may be a shortage of agents, and tasks begin to queue, waiting for agents to become available for connection, as shown in FIG. 2 from about time 7 to about time 21. Periods of time when a task assignment system has a shortage of available agents are referred to as “L2” environments. If a choice-based pairing strategy such as BP is used, the choice-based pairing strategy may choose from among any (or a subset) of the waiting tasks when an agent becomes available.

As agents become available to connect with tasks waiting in the queue, the size of the queue may decrease, as shown in FIG. 2 from approximately time 14 to about time 21. The task assignment system is operating in an L2 environment for this entire duration, but the choice available to BP or another choice-based pairing strategy becomes increasingly limited-instead of having as many as ten (or more) tasks available to choose among at about time 14, by about time 21 there are only two or three tasks in queue to choose among.

At some points in time, a task assignment system will transition from an L1 state to an L2 state (e.g., point 210A at about time 6 and point 210C at about time 40) or vice versa, from an L2 state to an L1 state (e.g., point 210B at about time 23). These crossover points along the x-axis (labeled the “1:1” line) occur when no choice is available to BP or another choice-based pairing strategy. For example, there may be a single task waiting in queue, which may be paired with whichever agent happens to become free next. Or there may be a single agent waiting idle, which may be paired with whichever task happens to arrive at the task assignment system next.

In some situations (not shown), a task assignment system may reach the “1:1” line and then bounce back up into L1 (or bounce back down into L2). No L1-to-L2 or L2-to-L1 transition occurs, but there is still a time at which no choice is available to BP.

In some situations (not shown), a task assignment system may remain along the “1:1” line for an extended period of time. In fact, a typical task assignment system may consider this line to indicate when the task assignment system is operating at a “perfect” capacity, with neither a surplus nor a shortage of agents for the given level of demand (e.g., number, frequency, and duration of tasks arriving at the task assignment system). In these situations, a BP strategy could go for an extended period of time with no choices available other than the “1 agent:1 task” default choice.

These points in time (or periods of time) when the task assignment system is operating along the “1:1” line, when a task assignment system has neither a surplus nor a shortage of available agents, are referred to as “L0” environments.

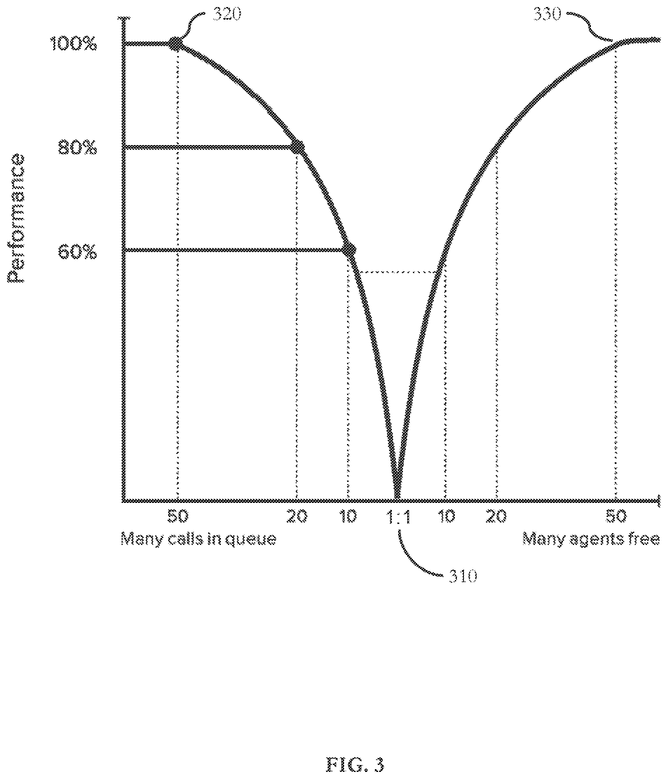

FIG. 3 depicts a schematic representation of a choice-based pairing strategy according to embodiments of the present disclosure. When choice is limited, choice-based pairing strategies may suffer from suboptimal performance. FIG. 3 shows an example of a performance estimate or performance simulation of a choice-based pairing strategy. When there are many tasks in queue (“many calls in queue” as in FIG. 3) (e.g., at point 320), or when there are many agents free (e.g., at point 330), BP or another choice-based pairing strategy may perform optimally (e.g., at or near “100%” instant performance or efficiency).

However, as the number of tasks in queue or free agents dwindle, there are fewer choices available to BP, and the performance or efficiency of BP could drop. In an L0 environment (e.g., at point 310), the instant performance or efficiency of BP is considered to be 0%, insofar as BP (without L3 pairing) is incapable of making a choice different from the pairing that any other non-L3 pairing strategy could make. In other words, if there is only one task waiting for an agent, and only one agent waiting for a task, both FIFO and BP will pair that one task with that one agent, with no other choice to make. As choice increases, either as tasks fill a queue in an L2 environment, or more agents become available in an L1 environment, performance steadily increases toward optimal instant performance.

In the example of FIG. 3, 50 calls in queue and 50 agents free are the points 320 and 330 at which this pairing strategy is expected to reach peak performance. However, in other embodiments or real-world task assignment systems, peak performance may be reached at varying levels of agent shortage or surplus (e.g., greater than 3 choices available, greater than 7 choices available, greater than 20 choices available, etc.).

In situations such as L0 environments in which the choice available to BP is too limited, it may be advantageous to delay or otherwise postpone connecting an agent to a task. Introducing a delay could allow time for another agent or another task to become available. If a task assignment system is operating in L0, and another agent arrives, the task assignment system will enter an L1 environment with two agents to choose between instead of being forced into the default selection. Similarly, if a task assignment system is operating in L0, and another task arrives, the task assignment system will enter an L2 environment with two tasks to choose between instead of being forced into the default selection.

In some embodiments, it may be desirable to delay even if the task assignment system already has some choice (e.g., already operating in L1 or L2), but the choice is limited. For example, if only ten tasks are waiting in queue when an agent becomes available, the pairing strategy of FIG. 3 is expected to have an instant performance of only 60%. It may be desirable to delay until closer to twenty tasks are waiting, at which point the expected instant performance would be closer to 80%.

When a delay is permitted, it is possible to enter a hybrid environment that is neither pure L1 nor pure L2. For example, consider a task assignment system in which there are two tasks in queue, and only one agent is available. Following a delay, a second agent could become available, resulting in an environment in which there are multiple tasks in queue and multiple agents available for connection. Periods of time when a task assignment system has multiple tasks in queue and multiple free agents are referred to as “L3” environments.

It is possible for a pairing module to perform or otherwise emulate a FIFO or FIFO-like pairing strategy while the task assignment system is in a L1 (agent surplus), L2 (task surplus), or L3 (multiple agents and multiple tasks) state. In these situations, the pairing module may always pair, for example, the longest-waiting task (or the higher-priority task) at the head of the queue with, for example, the longest-waiting agent, regardless of the other tasks in queue and available agents. In this sense, a FIFO pairing strategy is indifferent to L1, L2, and L3 environments, operating no more or less efficiently as in an L0 state. However, a choice-based pairing strategy such as BP can operate at higher average performance/efficiency when L1/L2/L3 states, with increased choice, are possible.

In some embodiments, a pairing module (e.g., task assignment strategy module 140) or a similar module may be capable of making an automated workforce management recommendation or decision within the task assignment system. For example, instead of preferentially trying to minimize task hold time and agent free time, which causes the task assignment system to hover around L0 or in periods of L1 and L2 with limited amounts of choice, the task assignment system could be advised or instructed to use a certain number of agents that is likely to keep the task assignment system in high-choice environments. In some situations, the recommendation could be to staff additional agents (e.g., 10 additional agents, 100 additional agents, etc.) to increase the expected amount of time spent in high-choice L1. In other situations, the recommendation could be to staff fewer agents (e.g., 10 fewer agents, 100 fewer agents, etc.) to increase the expected amount of time spent in high-choice L2.

In some embodiments, the workforce management instruction or recommendation may balance the cost of employing additional agents and increasing agent free time against the benefit of reducing task wait time, or balancing the cost-savings of employing fewer agents and decreasing agent free time against the cost of increasing task wait time. These recommendations may take into account the desired metric to optimize. For example, if the task assignment system management desires to optimize customer satisfaction, it may be desirable to make a recommendation that errs on being in high-choice L1 (agent surplus) rather than high-choice L2 (agent shortage). In either case, the recommendation or instruction may balance the cost of increasing agent free time or increasing task wait time against the improved performance/efficiency of BP or another choice-based pairing strategy operating in higher-choice L1, L2, or L3 environments, and avoiding inefficient LO environments in which only a default choice is available.

In some embodiments, the workforce management instruction or recommendation may be in the form of an estimated return on investment (ROI) of either employing additional agents or employing fewer agents. In a task assignment system, an ROI may be viewed as a monetary efficiency level. The estimated ROI may be defined by the following formulas:

$$Estimated ROI = \frac{\begin{matrix}( Profit with BP and more ( or fewer ) agents - \\ Profit without BP and more ( or fewer ) agents )\end{matrix}}{Costs of BP technology and more ( or fewer ) agents}$$

$$Profit without BP and more ( or fewer ) agents = Potential benefits from all tasks - Harm from lost tasks - Costs of agents$$

$$Profit with BP and more ( or fewer ) agents = Potential benefits from all tasks + Gain from BP - Harm from lost tasks - Costs of agents$$

In the above formulas, the potential benefits from all tasks may be treated as being fixed, regardless of the number of agents. However, in some embodiments using BP strategies, the benefits from all tasks may be different due to optimized task-agent pairing.

The harm from lost tasks, which depends on the number of agents, may be estimated from a survival/hazard analysis or a conversion rate analysis.

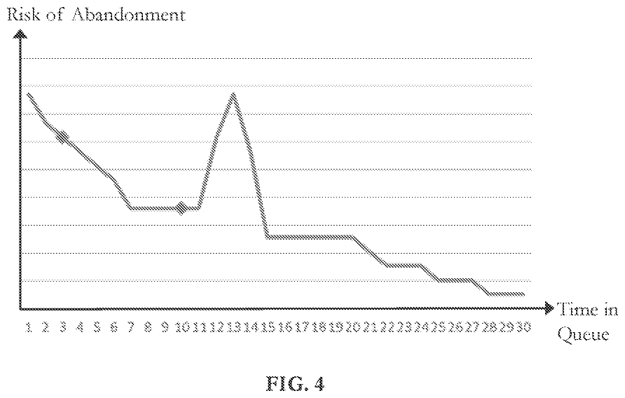

In a survival/hazard analysis, a hazard function may be used to determine the expected loss of each task. An example of a hazard function is illustrated in FIG. 4. As shown in this example, the risk of abandonment of each task (e.g., a caller hanging up and terminating a call) may depend on how long the task has been waiting in queue. In this example, the risk of abandonment during the first seconds after the task arrived is high. The risk begins to drop and then rises again on average around the 13th second.

Different queues in different task assignment systems may exhibit hazard functions with different characteristics. Hazard functions may be generated from historical information (e.g., starting times and ending times of calls) recorded by the task assignment systems. The time window for the hazard function may be chosen based on a task frequency rate (e.g., calls arrive about once every five seconds).

Given a hazard function, the expected loss of each task may be determined according to the following formula:

Expected loss=Risk of abandonment×Expected outcome

In this formula, the expected outcome of each task may be known or estimated based on outcomes of historical task-agent assignments in a task assignment system. For example, if the tasks are sales calls, each sales call may have an expected outcome, which may depend on the caller or type of caller, the item being sold, and the likelihood of the agent making the sale. The harm from lost tasks thus may be estimated from the expected losses of tasks in queue.

In a conversion rate analysis, the harm from lost tasks may be estimated from conversion rates of tasks based on historical data recorded by a task assignment system. For each task, an expected conversion rate may be a function of the task waiting in queue. In some environments, conversion rate may be directly correlated with waiting time. For example, in a sales queue of a contact center, a contact may be more likely to wait in queue if the contact has a strong intention to buy or order an item.

The gain from BP may be determined from historical data recorded by a task assignment system and a statistical analysis (e.g., a Bayesian analysis) to establish a dependence between task-agent pairing choices (which depend on the number of agents) and gain in L1, L2, and/or L3 environments (e.g., FIG. 3). Alternatively, a task assignment system may be simulated using a simulator to estimate such a dependence.

A pairing module (e.g., task assignment strategy module 140) or a similar module may estimate a plurality of ROIs for a plurality of numbers of agents-more or fewer than the number of agents typically employed. The highest (positive) estimated ROI may then inform the task assignment system of the optimal number of agents to employ in order to maximize the benefits of using a BP strategy. In some instances, the recommended number of agents may be higher than the number of agents typically employed, and the task assignment system may operate in a higher-choice L1 (agent-surplus) environment more often. In other instances, the recommended number of agents may be lower than the number of agents typically employed, and the task assignment system may operate in a higher-choice L2 (task-surplus) environment more often.

In a task assignment system, the ROI may be estimated by a calculator. The calculator may be implemented as a web-based, app-based, etc. user interface. The calculator may generate reports (e.g., PDF, Word, spreadsheets, etc.), which may be used for workforce management, sales, account management, or further statistical analysis.

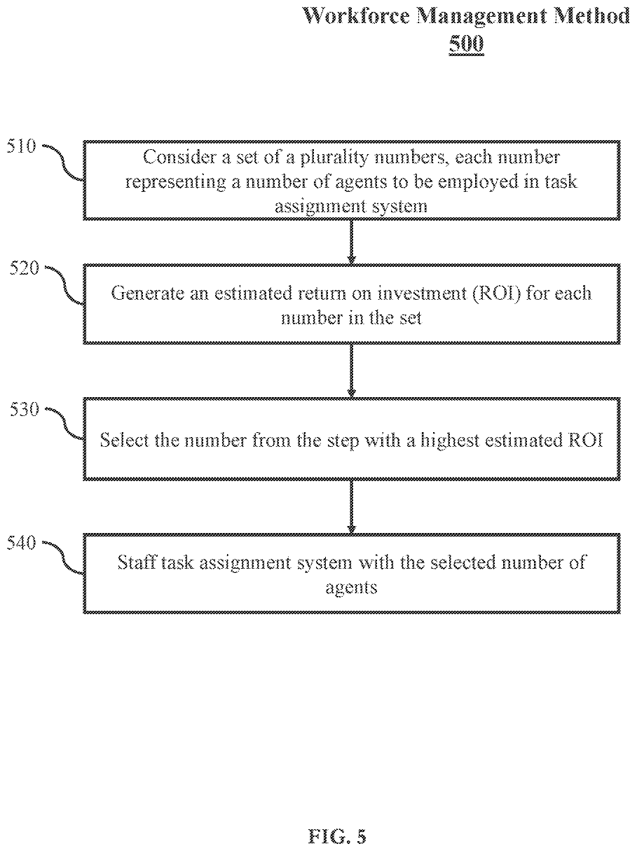

FIG. 5 shows a flow diagram of a workforce management method 500 according to embodiments of the present disclosure. Workforce management method 500 may begin at block 510. At block 510, a set of a plurality of (integer) numbers (e.g., {10, 11, 12, . . . , 1000}) may be considered. Each number in the set may represent a number of agents to be employed in a task assignment system. Workforce management method 500 may then proceed to block 520. At block 520, for each number in the set, an estimated ROI may be generated, as described above. At block 530, workforce management method 500 may select the number in the set that results in a highest estimated ROI. Workforce management method 500 may proceed to block 540, where the task assignment system may be staffed with the selected number of agents.

At this point it should be noted that estimating ROI in a task assignment system in accordance with the present disclosure as described above may involve the processing of input data and the generation of output data to some extent. This input data processing and output data generation may be implemented in hardware or software. For example, specific electronic components may be employed in a pairing module or similar or related circuitry for implementing the functions associated with estimating ROI in a task assignment system in accordance with the present disclosure as described above. Alternatively, one or more processors operating in accordance with instructions may implement the functions associated with estimating ROI in a task assignment system in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method comprising:
obtaining, by at least one computer processor configured to operate in a contact center system, contact data;
determining, by the at least one computer processor, a first plurality of agents;
determining, by the at least one computer processor, a first contact center choice measurement based on the contact data and the first plurality of agents;
determining, by the at least one computer processor, a second plurality of agents;
determining, by the at least one computer processor, a second contact center choice measurement based on the contact data and the second plurality of agents;
selecting, by the at least one computer processor, a third plurality of agents based on the first contact center choice measurement and the second contact center choice measurement, wherein a contact queue size associated with the third plurality of agents is greater than at least one of i) a queue size associated with the first plurality of agents and ii) a queue size associated with the second plurality of agents; and
establishing a connection between an agent of the third plurality of agents and a contact in a switch of the contact center system based upon the third plurality of agents.
